(19) United States
(12) Patent Application Publication
(10) Pub. No.: US 2026/0254532 A1
(43) Pub. Date: Aug. 27, 2026

(54) DEVICE FOR TRANSMITTING OPTICAL-WIRELESS SIGNALS

(71) Applicant: Fraunhofer-Gesellschaft zur Förderung der angewandten Forschung e.V., München (DE)

(72) Inventors: René KIRRBACH, Dresden (DE); Tobias SCHNEIDER, Dresden (DE); Philipp MEIßNER, Dresden (DE)

(73) Assignee: Fraunhofer-Gesellschaft zur Förderung der angewandten Forschung e.V., München (DE)

(21) Appl. No.: 19/547,664

(22) Filed: Feb. 23, 2026

(30) Foreign Application Priority Data
Feb. 24, 2025 (DE) 102025106919.0

(51) Int. Cl. H04B 10/11

(52) U.S. Cl. CPC H04B 10/11

(57) ABSTRACT

A device for transmitting optical-wireless signals includes a signal source for providing at least one signal and a plurality of spatially distributed optical transmitters for transmitting a corresponding plurality of optical-wireless signals. Furthermore, a synchronization unit configured to convert the at least one signal for the plurality of optical transmitters into a corresponding plurality of input signals synchronized with each other is arranged. Based on the at least one signal, the plurality of optical-wireless signals is transmitted spatially distributed as mutually synchronized optical-wireless signals by the plurality of optical transmitters based on the plurality of mutually synchronized input signals.

### CROSS-REFERENCE TO RELATED APPLICATION

This application is a continuation of copending German Applications No. DE 10 2025 106 919.0, which was filed Feb. 24, 2025, and is incorporated herein by reference in its entirety.

The present patent application relates to a device for transmitting optical-wireless signals and to a system with such a device. The present invention relates in particular to an off-axis optical rotary transmitter that uses a laser diode (LD) ring.

### BACKGROUND OF THE INVENTION

Advancing digitalization is leading to more and more applications in which data has to be transmitted across rotating parts. The requirements for these rotary transmitters with respect to data rate, latency, and reliability increase constantly, making new technologies essential. Classic slip rings have a limited service life due to mechanical abrasion. So as to minimize downtime and maintenance times, abrasion-free, i.e. contactless, technologies are being used more and more. Key requirements for slip rings resulting from these applications are: data rate (>=1 Gbps), low latency, high reliability, long service life, low unit costs, and high electromagnetic compatibility. Depending on the applications, the rotary transmitter has to be placed on the axis of rotation, or outside of the axis of rotation when there is no space available. Current technical solutions, in particular outside of the axis of rotation, do not satisfactorily meet all technical requirements.

Current solutions for rotary transmitters outside of the axis of rotation are typically coupled capacitively [1]. Usually, these solutions are limited in their data rate to <=1 Gbps and are susceptible to electromagnetic interference [2]. The tolerance and assembly requirements for capacitive coupling are high for high data rates so that capacitive coupling may be cost-intensive.

Inductive coupling is also possible [3], but the systems tend to be large and susceptible to EMI and may also interfere with other sensible electric devices nearby. In addition, they have a very limited range of a few millimeters [4], which may lead to increased complexity of the rings or partially limited use cases.

Data transmission could be carried out by means of radio [1, 5], but radio systems are susceptible to interferences and have rather poor electromagnetic compatibility. For some applications, there are safety risks due to other radio signals. Since the rotary transmitters are often used in industrial environments where reliability is an important parameter, radio solutions are not suitable for reliable rotary transmitters due to fluctuating data rates and variable high latencies.

The use of optical transmission is fundamentally promising due to the potentially high data rate and high electromagnetic compatibility. On the axis of rotation, there are commercial solutions with optical-wireless transceivers [6-8] or fiber-coupled transceivers (fiber rotary optical joint, FROJ) [1]. Outside of the axis of rotation, optical transmitters currently do not play a significant role.

Helzel and Martens [9] investigate an optical slip ring outside of the axis of rotation, which operating with a transmission and a reception element. The transmitted signal is held on the ring track by a reflective ring and is directed out of the ring to the detector by the receiver through an optical element. The problem with this approach is the limited data rate (140 mbit/s) and the necessity of cost-intensive ring-diameter specific optics, i.e. the mirror in this case.

Thus, there is a need to improve optical-wireless communication, in particular in case of a relative movement of components with respect to each other.

Thus, it is the object of the present invention to provide a device for transmitting optical-wireless signals, enabling reliable communication even in the case of a relative movement to a receiver of the optical-wireless signals, and in particular in case of high relative speeds.

### SUMMARY

An embodiment may have a device for transmitting optical-wireless signals, comprising: a signal source for providing at least one signal; a plurality of spatially distributed optical transmitters for transmitting a corresponding plurality of optical-wireless signals; a synchronization unit configured to convert, for the plurality of optical transmitters, the at least one signal into a corresponding plurality of mutually synchronized input signals; wherein the device is configured to, based on the at least one signal, with the plurality of optical transmitters, based on the plurality of mutually synchronized input signals, transmit the plurality of optical-wireless signals in a spatially distributed way as mutually synchronized optical-wireless signals.

Another embodiment may have a system for transmitting optical-wireless signals, comprising: a device according the invention as a first device; and a second device for receiving at least a subset of the synchronized optical-wireless signals.

It is a core idea of the present invention to have recognized that a synchronization of optical-wireless signals transmitted by the device and with a plurality of optical transmitters enables a receiver to move relative to the transmitters, and that a synchronization of the optical signals is of advantage in case of the receiver switching from an optical signal of the first transmitter to an optical signal of a second transmitter since it enables continuous reception, or seamless transmission of optical signals. This is of particular advantage in case of high desired data transmission rates, since, with data rates of Gbit/s, the optical runtime may lead to asynchronous output signal in means for beam division already. Background for this is that the bit length is in the range of ns, and path length differences there become relevant with the speed of light. Thus, according to the invention, synchronization means are used to synchronize the optical output signals with respect to each other so as to solve the problems mentioned above.

According to an embodiment, a device for transmitting optical-wireless signals includes a signal source for providing at least one signal and a plurality of spatially distributed optical transmitters for transmitting a corresponding plurality of optical-wireless signals. The device further includes a synchronization unit (or synchronization means) configured to convert, for the plurality of optical transmitters, the at least one signal into a corresponding plurality of mutually synchronized input signals. The device is configured to, based on the at least one signal, with the plurality of optical transmitters, based on the plurality of mutually synchronized input signals, transmit the plurality of optical-wireless signals in a spatially distributed way as mutually synchronized optical-wireless signals. This enables smooth reception of the respective signal, or joining together different sub-signals for the case in which a receiver moves with respect to the optical transmitters and the switch from a transmitter to a different transmitter exemplarily takes case during a data packet.

According to embodiments, the signal source is configured to provide the at least one signal as a data signal, wherein the plurality of optical-wireless signals are synchronized signals of matching data content. This enables reliable data transmission even in case of high relative movement speeds.

According to an embodiment, the synchronization unit is configured to electrically passively compensate different runtimes of the at least one signal from the signal source to the plurality of optical transmitters. For example, this may be done by equalizing line lengths and/or by using buffer means to ensure that the respective signals reach the optical transmitter at the same time and that a simultaneous conversion of the signals occurs, although the embodiments are not limited thereto.

According to an embodiment, the synchronization unit is equipped with at least one buffer, or signal buffer, comprising a signal input coupled to the signal source so as to receive the signal. The buffer comprises a plurality of signal outputs and is configured to output, on the basis of the signal, a plurality of buffer output signals as synchronous buffer output signals. The input signals of the optical transmitters, coupled to the signal outputs, of the plurality of optical transmitters are based on the buffer output signals and/or are the buffer output signals. This enables the advantageous use of buffer properties in that they may simultaneously provide a signal at different signal outputs.

According to an embodiment, the signal lines between the plurality of signal outputs of the buffer on the one hand and the optical transmitters coupled to the signal outputs on the other hand are configured such that they comprise an essentially matching line length. This enables obtaining essentially matching runtime delays in the line lengths and maintaining the synchronicity.

According to an embodiment, positions of the optical transmitters coupled to the signal outputs are distributed in a transmitter area and/or the positions of the transmitter means are specified. The buffer is essentially arranged in the center of the transmitter area, which advantageously enables having an essentially equal line length with respect to the edges of the transmitter area. Furthermore, the conductive paths are distributed more equally along the ring and a spatial bottleneck at the signal source is avoided. Alternatively or additionally, neighboring optical transmitters arranged along different signal paths starting from the signal source may have an essentially equal distance and/or runtime delay of the input signals.

According to an embodiment, the device comprises a plurality of buffers, wherein each of at least a subset of the plurality of buffers is coupled to a subset of the plurality of optical transmitters. That means that several buffers may be coupled to a respective plurality of optical transmitters. This enables simplification of the synchronization task in that the synchronization of the signal inputs of the buffers may reduce a subsequent synchronization complexity.

According to an embodiment, the plurality of buffers is arranged in a cascading arrangement of buffers. This means that, in addition to the subset of buffers, additional buffers of an additional cascading stage may be implemented, which advantageously enables the synchronization of several buffers with respect to each other by using a further buffer.

According to an embodiment, the subset of the optical transmitters fully covers a transmitter area, and the subsets of the optical transmitters essentially cover sub-areas of the transmitter area of the same size. Such a symmetry is advantageous for the synchronization of optical signals.

According to an embodiment, the plurality of optical transmitters is arranged along a circular path, and the plurality of optical transmitters is arranged at a carrier substrate comprising a circular or annular geometry, and the plurality of optical transmitters is arranged annularly at the substrate. This enables advantageous adjustment with respect to a rotational movement of the device and/or a device for receiving the optical signals, in other words, a relative movement between these devices along a circular path.

According to an embodiment, the device further includes at least one optical receiver configured to receive an optical-wireless signal from a different device and to convert the same. This enables bidirectional transmission of optical-wireless signals with the other device.

According to an embodiment, the signal source is configured for data processing, and comprises a signal amplifier, and the amplification of the signal amplifier may be controlled adaptively. This enables an advantageous adjustment of the optical-wireless signals.

According to an embodiment, one, several, or all of the optical transmitters are configured to include a buffer circuit or driver circuit and an optical emitter. This enables provision of an optical transmitter as integrated means.

According to an embodiment, at least one of the optical transmitters includes a lens, a reflector, and/or a diffuser so as to optically shape, i.e. to collimate or scatter, light generated by the optical transmitter on the basis of the input signal, which enables an additional degree of freedom for an adjustment of the optical-wireless communication.

According to an embodiment, at least one of the optical transmitters includes a multi-path lens configured to split light power of light generated by the optical transmitter on the basis of the input signal into several light sub-bundles, which advantageously enables fulfillment of requirements, e.g. with respect to eye safety or the like, and simultaneously cover a larger spatial area with the optical-wireless signals.

An embodiment provides a system implemented for transmitting optical-wireless signals. To this end, a device according to the embodiments described herein is provided as a first device, and a second device for receiving at least a subset of the synchronized optical-wireless signals is provided. This subset relates to the fact that due to the synchronized implementation of the optical-wireless signals, it may be sufficient that the second device may receive only one of these signals, a plurality of signals, or all of the signals, but that the reception of one of the optical-wireless signals may already be sufficient to successfully transmit the energy and/or data transmitted therewith.

According to an embodiment, at least the second device comprises a plurality of spatially distributed optical receivers. This enables a further increase of the reliability of the optical transmission.

According to an embodiment, a first optical receiver and a neighboring second optical receiver of the second device comprise a distance that is essentially half of, or an odd-numbered multiple of half of, a distance between two neighboring optical transmitters of the first device, i.e., with a natural number n. This makes it possible to advantageously ensure that there is always enough optical-wireless power at least at one of the optical transmitters to increase the reliability of the optical communication.

According to an embodiment, the second device includes an amplifier circuit coupled to the first optical receiver and the second optical receiver so as to amplify a first receiver signal of the first optical receiver and a second receiver signal of the second optical receiver. This enables the synergetic use of an amplifier circuit for two or several optical receivers, wherein the amplification may be done optically and/or electrically. At the same time, a combination of the reception signals may take place in such a circuit.

According to an embodiment, an amplifier circuit of the second device is configured to amplify a first receiver signal of the first optical receiver so as to provide a first amplified signal. A second amplifier circuit of the second device is configured to amplify a second receiver signal of the second optical receiver so as to provide a second amplified signal. To this end, the second device includes a processing unit (or processing means) for combining the first amplified signal and the second amplified signal, which enables individual functional planning with respect to a combination in the amplifier circuit.

An embodiment provides a variation of this, by the two amplifier circuits receiving and amplifying the first and second receiver signals, respectively, of the first and second optical receivers, respectively, and being configured to provide a first and second amplified signal, respectively. The second device includes a processing unit (or processing means) configured to perform data processing of amplified signals and to select one of the first amplified signal and the second amplified signal for data processing. This may advantageously enable compensation of any remaining runtime differences in the received optical-wireless signals, e.g. by switching between the respective processed amplified signal, on the basis of signal amplitudes, signal-to-noise ratios, SNRs, or the like. For example, switching may take place at points in time at which reinitialization of a corresponding operation step is carried out, e.g. between two subsequent data packets or the like.

An embodiment may provide a system in which a movement path (or trajectory or movement track) of a relative movement between the first device and the second device is arranged such that in each relative position of the relative movement, at least one optical transmitter of the first device is arranged in a reception area (or range) of an optical receiver of the second device. This enables smooth transmission of optical-wireless signals.

According to an embodiment, single reception areas of the individual spatially distributed receivers of the second device together define a total reception area (or range). In other words, the total reception area may be understood to be a combination of the individual reception areas. The plurality of optical transmitters is configured to illuminate the total reception area with gaps. Due to the synchronized optical-wireless signals, it is possible, but not required, to carry out full illumination, however, in order to save weight, material, and costs, a reduced number of transmitters may be used, since it may be sufficient that at least one of the receivers always receives one of the synchronized signals.

According to an embodiment, the first device and the second device are arranged so as to be rotatable around a mutual axis of rotation. Alternatively or additionally, the second device is movable in an area illuminated by the plurality of synchronized optical-wireless signals.

According to an embodiment, the devices are arranged around a mutual axis of rotation, and a coverage area (or range) generated by the plurality of synchronized optical-wireless signals essentially matches a movement path of the second device in the system. This enables one of the optical receivers to always be arranged in the coverage area.

According to an embodiment, the second device comprises an amplifier unit (or amplifier means) coupled to an optical receiver and arranged close to the optical receiver. This enables low runtime delay between the optical receiver and the amplifier unit and a low-noise low, space-saving design.

According to an embodiment, the second device of the system is arranged to detect, depending on a relative position between the first device and the second device, at least one of the plurality of synchronized optical-wireless signals, which makes it possible to provide seamless transmission of optical-wireless signals.

According to an embodiment, each of the plurality of synchronized optical-wireless signals is configured to illuminate a sub-area (or partial area) of a total area, wherein the sub-areas overlap at the second device. This may be carried out to such an extent that a continuous area is obtained as a coverage area, however, which, as described above, is not required, and two or more sub-areas may be obtained.

According to an embodiment, the plurality of synchronized optical-wireless signals is a first plurality of synchronized optical-wireless signals of a first optical-wireless communication channel. The first and/or the second device comprises a further plurality of synchronized optical transmitters to provide a further optical-wireless communication channel either as a return channel or as an additional channel along the same direction.

Additional communication channels may be easily provided, enabling additional degrees of freedom in the implementation of the communication.

According to an embodiment, the first plurality and the further plurality are arranged on different concentric paths and/or configured for different wavelength ranges. This enables error-free separation of the channels.

According to an embodiment, the system is configured for bidirectional transmission of optical-wireless signals.

According to an embodiment, a system described herein is configured for transmission of electric energy on the basis of at least one optical-wireless energy signal and from the first device to the second device or from the second device to the first device. This means that the synchronized property of signals described above may be used advantageously for data signals, however, it may also readily be used for the transmission of optical energy so as to later convert the same into electric energy for operating electric components and/or for charging energy storages.

According to an embodiment, the system comprises optical emitters for the transmission of the at least one optical-wireless energy signal, wherein the optical emitters are arranged along a movement path of a relative movement between the first device and the second device, and cover areas of the optical emitters together cover the entire movement path.

### BRIEF DESCRIPTION OF THE DRAWINGS

Embodiments of the present invention will be detailed subsequently referring to the appended drawings, in which:

FIG. 1 shows a schematic block circuit diagram of a device according to an embodiment;

FIG. 2 shows a schematic perspective view of a system according to an embodiment;

FIG. 3 shows a schematic top view of a device according to an embodiment, with a multitude of optical transmitters;

FIG. 4a shows a schematic top view onto the device according to FIG. 3, wherein radiation areas of the optical transmitters are formed so as to be round;

FIG. 4b shows a schematic top view onto the device according to FIG. 3, wherein radiation areas of the optical transmitters are formed so as to be elliptical;

FIG. 5 shows a schematic top view onto an optical device according to an embodiment, comprising several modifications with respect to the device of FIG. 3;

FIG. 6 shows a schematic block circuit diagram of at least a part of a system arrangement of embodiments described herein;

FIG. 7 shows a schematic top view onto a device according to an embodiment, with an arrangement of at least two optical receivers;

FIG. 8a shows a schematic top view on such a transmission ring of the rotary transmitter with optical-wireless energy transmission; and

FIG. 8b shows a schematic top view on a reception ring of a rotary transmitter with optical-wireless energy transmission.

### DETAILED DESCRIPTION OF THE INVENTION

Before the following embodiments of the present invention are explained in detail with reference to the drawings, it should be noted that identical elements, objects and/or structures or elements, objects and/or structures with the same function or the same effect are provided with the same reference numerals so that the description of these elements shown in different embodiments is interchangeable or can be applied to each other.

Embodiments described below are described in connection with a multitude of details. However, embodiments may also be implemented without these detailed features. Furthermore, for the sake of clarity, embodiments are described using block diagrams as a substitute for a detailed description. Furthermore, details and/or features of individual embodiments may be combined with each other without further ado, unless explicitly stated otherwise.

The following embodiments relate to optical-wireless signal transmission or data transmission. Within the scope of the embodiments described herein, this may also be referred to as LiFi (Light Fidelity; light transmission). Terms such are IRDA (Infrared Data Association) or OWC (Optical Wireless Communication) can be understood as optical-wireless transmissions. This means that the terms “optical-wireless data transmission” and “LiFi” are used synonymously. Optical wireless data transmission is here understood to mean the transmission of an electromagnetic signal through a free transmission medium, such as air or another gas or a fluid. For this purpose, e.g., wavelengths in the ultraviolet (UV) range of at least 53 nm and the infrared range of at most 1550 nm may be used, although other wavelengths that differ from those used for radio standards are also possible. Optical wireless data transmission also has to be distinguished from fiber-optic data transmission, which is implemented, e.g., by means of optical wave guides or of optical wave guide cables. The terms transmitter and sender are used as synonyms. The same applies to the terms receiver and recipient.

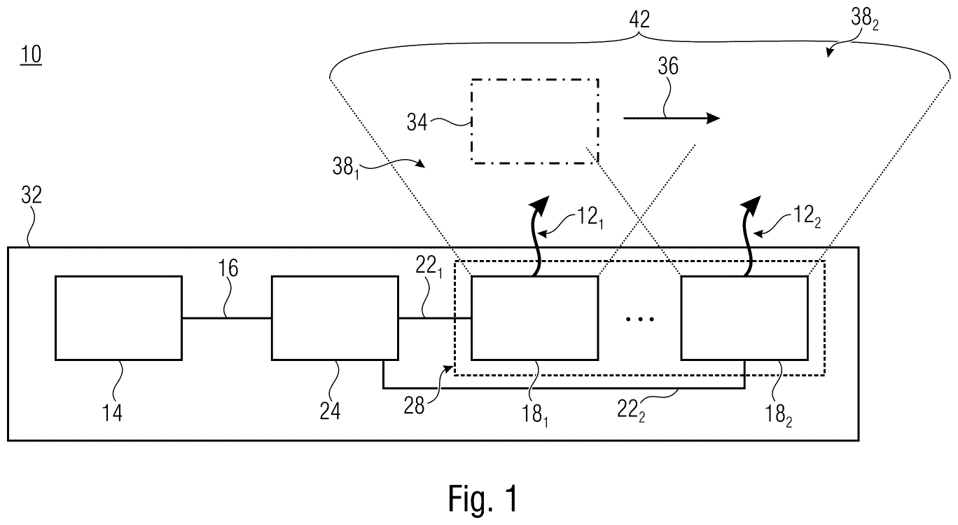

FIG. 1 shows a schematic block circuit diagram of a device 10 according to an embodiment. The device 10 is configured for emitting optical-wireless signals 12₁, 12₂ and possibly further optical-wireless signals. To this end, the device 10 includes a signal source 14 for providing at least one signal 16. The signal 16 may be an electric signal, an optical signal, or may be provided with a different energy form. In this case, it is possible, but not required, for the signal source 14 to provide the signal 16 at only one signal output, however, it may also be provided several times at several signal outputs. In this case, the signal 16 may be a data signal or an energy signal, the present invention can be implemented with both types of signals. According to the embodiments described herein, a data signal is understood to be a signal for transmitting information, even if a signal power≠0, i.e. different from ZERO, is used in this case. However, the signal power is significantly smaller than in case of an energy signal whose object may be to enable conversion from the optical-wireless signal into electric energy at the location of the receiver, wherein this energy may be used to electrically operate components and/or to charge energy storages. To this end, the aim is usually to transmit the highest possible signal powers, whereas this is not usually necessary for data signals.

The apparatus 10 includes a plurality of spatially distributed optical transmitters 18₁, 18₂, i.e. at least two, at least three, or more, configured to provide or emit, on the basis of a respective input signal 22₁ and 22₂, respectively, the respective optical-wireless signal 12₁ and 12₂, respectively. To this end, the optical transmitters 18₁ and/or 18₂ may include elements for the generation of light, such as light diodes, laser diodes, or the like, so as to convert electric input signals 22₁ and 22₂. Such a conversion may be unnecessary if the input signals 22₁ and 22₂ are already optical in nature.

Furthermore, the apparatus 10 comprises a synchronization unit (or synchronization means) 24 configured to convert the signal 16 for the plurality of optical transmitters 18₁, 18₂ into a corresponding plurality of input signals 22₁ and 22₂, wherein these input signals are synchronized with respect to each other, at least with respect to the location of the transmitters 18₁ and 18₂. In other words, due to the synchronization unit 24, the input signals 22₁ and 22₂ reach the optical transmitters 18₁ and 18₂ such that the optical-wireless signals 12₁ and 12₂ are emitted in a synchronized manner. When considering an embodiment of the present invention in which the optical transmitters 18₁ and 18₂ are of the same structure and are implemented with essentially the same electric-optical features, the aim of this implementation might be to provide the input signals 22₁ and 22₂ so as to reach the optical transmitters 18₁ and 18₂ simultaneously and in a synchronized manner.

Such a synchronization may include a time delay for compensating different runtimes (or propagation times) to the optical transmitters 18₁ and 18₂ and/or may include an implementation of different runtimes for compensating different distances between the signal source 14 and the optical transmitters 18₁ and/or 18₂ or sections thereof.

Such an implementation enables the device to emit, on the basis of the at least one signal 16, the plurality of optical-wireless signals 12₁ and 12₂ spatially distributed as synchronized optical-wireless signals 12₁ and 12₂ with the plurality of optical transmitters 18₁ and 18₂ on the basis of the plurality of synchronized input signals 22₁ and 22₂.

The plurality of transmitters 18₁, 18₂ and further transmitters may be understood to be a continuous transmitter area (or range) 28 which is illustrated larger than the sum of the optical transmitters 18₁ and 18₂ only for the sake of clarity, and may be understood to be the smallest possible polygonal surface area that is spanned on a one-piece or multi-piece carrier substrate 32 of the device 10 by the optical transmitters 18₁, 18₂ connected to the synchronization unit 24 and/or signal source 14.

The arrangement and functionality of the components described enables a relative movement of a receiver device 34 along a movement direction 36 across several illumination areas 38₁, 38₂ of the respective optical transmitters 18₁ and 18₂, respectively, which may together define a coverage area 42 illuminated by the synchronized optical-wireless signals 12₁ and 12₂, to go along with a seamless reception of optical signals. Since the optical signals 12₁ and 12₂ are synchronized, a signal hop or a temporal displacement within the received signal or the like may be avoided in the transition of the receiver 34 from the illumination area 38₁ to the illumination area 38₂ or vice versa, which is advantageous.

In this case, it is possible, but not required, that the movement direction 34 extends along a linear path (or track), however, curved or in particular circular paths (or tracks) are also possible.

The apparatus 10 of FIG. 1 enables transmission of electric energy and/or data towards the receiver 34. This channel, which may be configured as a single channel, may be extended by additional channels to the receiver 34 for transmitting the other option as data and energy and/or additional channels may be arranged for transmitting further data or additional energy. In a particular advantageous embodiment, the device 10 comprises optical receivers to receive optical-wireless signals from the device 34.

The synchronization unit 24 may be configured to actively compensate different runtimes of the signal, or between the signals 22₁ and 22₂, towards the optical transmitters 18₁, 18₂, e.g. perform transmission at different times. Alternatively or additionally, the synchronization unit 24 may be configured to electrically passively compensate different distances between the signal source 14 and the plurality of optical transmitters 18₁, 18₂, e.g. by additional runtime delays in a comparatively shorter direct route. For example, such runtime delays may be realized by different line lengths and/or by the use of buffers, at the output side of which a matching runtime delay with respect to the optical transmitters connected thereto is obtained.

By equalizing the line length and/or by an appropriate, e.g. central, selection of a location of a buffer, it can be achieved that signal lines between the plurality of signal outputs of the signal source or the buffer on the one hand and the optical transmitters coupled to the signal outputs on the other hand essentially have a matching line length. For example, essentially matching may include a relative relationship with respect to each other, e.g. within a tolerance range of e.g. at most a deviation of 100%, at most a deviation of 90%, or at most a deviation of 80%, however, it may also relate to a deviation considering a bitlength in an optical-wireless data signal, e.g., so that the deviation of the line length leads to a deviation in temporal course between the optical-wireless signals, causing at most 5% percent of a bitlength, at most 10% percent of a bitlength, or at most 35% of a bitlength, or the like.

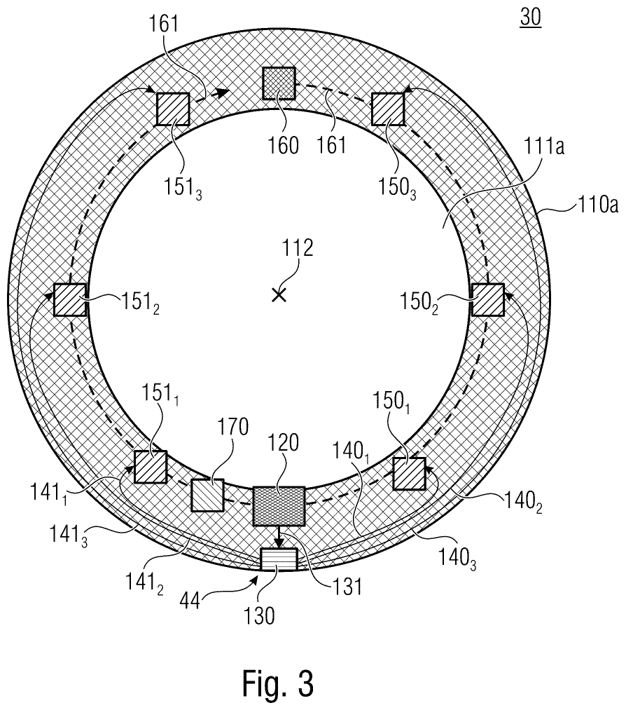

Alternatively or additionally, neighboring optical transmitters arranged along different signal paths starting from the signal source, e.g. the transmitters 150₃ and 151₃ of FIG. 3, may have an essentially same distance and/or runtime delay of the input signals. Due to both variations, a signal hop that a receiver moving relative to the device experiences may be avoided, e.g. when the receiver switches from the signal of the transmitter 150₃ to the signal of the transmitter 151₃ or vice versa.

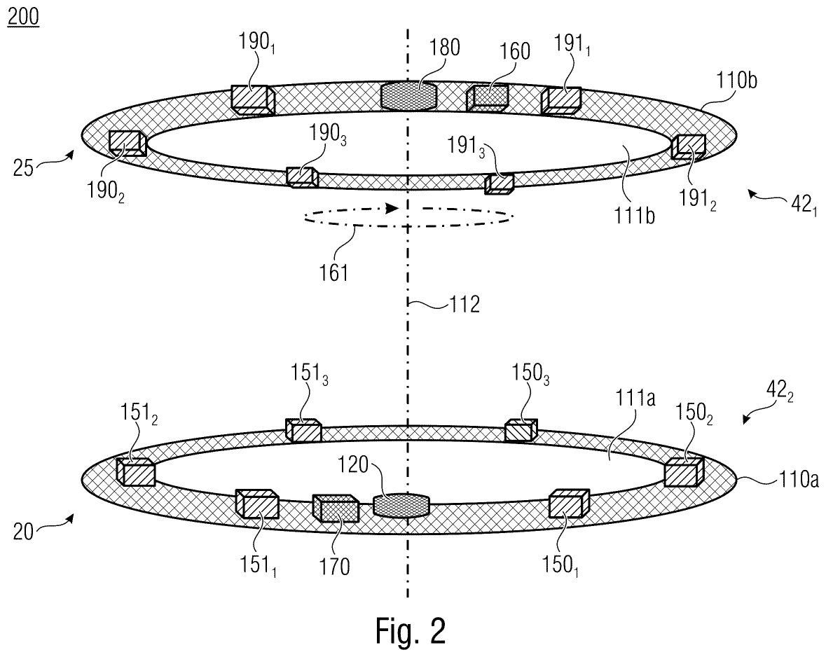

FIG. 2 shows a schematic perspective view of a system 200 according to an embodiment, comprising two devices 20 and 25 according to embodiments, configured according to the device 10. The devices 20 and 25 are arranged so as to be movable around a mutual axis of rotation 112, which may mean that the device 20 is supported with respect to the device 25 so as to be rotatable around the axis of rotation 112, or the device 25 is supported with respect to the device 20 so as to be rotatable around the axis of rotation 112, or both devices 20 and 25 are supported so as to be rotatable around the axis of rotation 112, wherein this may include a matching direction of rotation or an inverse direction of rotation, so that a movement direction 36 of FIG. 1 is here illustrated as an arrow path 161.

For example, the device 20 includes controlling means 120 configured as a data source or data sink, which may be in accordance with the signal source 14. A corresponding signal or individual signals may be transmitted to optical transmitters 150₁, 150₂, 150₃ as well as 151₁, 151₂ and 151₃, e.g. by a respective signal line being arranged at an e.g. annular substrate 110 formed in accordance with the carrier substrate 32.

The transmitters 150 and 151 may be formed in accordance with the optical transmitters 18₁, 18₂, . . . of FIG. 1. For example, the synchronization unit 24 of FIG. 1 may be part of the control means 120, wherein further alternative or additional possibilities are described in the context of the present disclosure.

A possibly, but not necessarily, equidistant arrangement of the transmitters 150, 151 on the ring 110a may provide for a uniform illumination of a coverage area 42₁, in which the ring 110b of the device 25 is located, in particular an optical receiver 160 of the device 25. Thus, full coverage of the coverage area 42₁ such that the ring 110 is fully illuminated may achieve that the optical receiver 160 receives at least one of the signals of the optical transmitters 150₁-150₃ and/or 151₁-151₃ in any rotational position of the devices 20 and 25 with respect to one another, and a transition from one illumination area to the other may take place seamlessly.

The arrangement of the optical transmitters 150 and 151 shows an exemplary positioning of the optical transmitters in a respective half of the ring 110a, which is non-limiting and illustrated only for better understanding.

The device 25 may be built equivalently to the device 20 and may have optical transmitters 190₁-190₃ as well as 191₁-191₃ corresponding to the optical transmitters 150₁-150₃ as well as 151₁-151₃, which may also be configured in accordance with the optical transmitters 18 of the device 10. An arrangement equal to or similar to the device 20 enables an optical receiver 170 of the device 20 to receive one of the optical-wireless signals of the transmitters 190, 191 in any rotational position of the devices 20 and 25.

To this end, the device 25 may include control means 180 that may be formed in accordance with the signal source 14 of FIG. 1. For example, the synchronization unit 24 of FIG. 1 may be part of the control means 180, wherein, in the context of the present disclosure, further alternative or additional possibilities are described. A possible optional, but not required, free inner area or inner diameter 111a and 111b of the device 20 and 25, respectively, may enable to also arrange the device 20 and 25, respectively, around a rotatably supported device. If, alternatively or additionally, rotating areas are opposite to each other, the inner area 111 may also not be required or necessary.

In the case of bidirectional combination of both, the signal sources 120 and 180 may also be formed as a data sink and may be configured for data processing. In the case of energy transmission, a corresponding adaption of the means 120 and/or 180 may be carried out. Here, the signal sources or signal sinks 120 and 180 may also be referred to as controllers and, in the case of the implementation of the system 200 described, the devices 20 and 25 may also be referred to as rotary transmitters.

Embodiments of the present invention enable a contactless optical-wireless rotary transmitter for high-speed communication. As the embodiment in FIG. 2 shows, the rotary transmitter, i.e. the system 200, includes two opposite devices 20 and 25, e.g. including ring structures 110a and 110b. The rings have an optional free inner space/inner diameter 111a and 111b. Both free inner diameters may have the same size, however, this is not required. One ring, both rings, or none of the rings may rotate around the axis of rotation 112. The relative rotation of the rings with respect to each other, is shown by the arrow path 161. Both rings have a data source or data sink 120 or 180, respectively. Each data source/data sink may be, or include, an interface or a controller block.

In a unidirectional implementation, a transmission ring is located on at least one of the rings 110a, 110b, in accordance with embodiments, including transmission blocks 150₁, 150₂, 150₃, 151₁, 151₂, 151₃ or 190₁, 190₂, 190₃, 191₁, 191₂, 191₃, depending on whether, with respect to the device 20 to the device 25, a forward direction or a return direction is selected for transmitting optical-wireless signals. Bidirectional transmission can easily be implemented if, on both sides, transmitters and at least one receiver are arranged, as illustrated in FIG. 2. An optical receiver 160 or 170 is arranged on the respective other ring so as to ensure communication within the specification, i.e. the operating arrangement, regardless of position. In an implementation for bidirectional communication, as shown in FIG. 2, both rings have a transmitter function and a receiver function, i.e. a transmitter part and a receiver part.

In other words, FIG. 2 shows an embodiment of an optical-wireless rotary transmitter, i.e. a transmission system, including two rings 110a and 110b with one free inner diameter 111a and 111b. One of the rings, both, or none of the rings may rotate about the axis of rotation 112.

FIG. 3 shows a schematic top view onto a device 30 according to an embodiment, e.g., which may implement the device 20 or 25 of the system 200.

The top view illustrates the optical transmitters 150₁-150₃ as well as 151₁-151₃, which may move along the circular path 161 at least as a relative movement of an opposite device, as shown by the axis of rotation 112.

Furthermore, FIG. 3 shows the advantageous use of a buffer or signal buffer 130 as at least a part of the synchronization unit, e.g. the synchronization unit 24 of the device 10. The buffer 130 may comprise a signal input to receive a signal 131 from the signal source 120 at the signal input. To this end, the signal input of the buffer 130 is coupled to the signal source 120. Furthermore, the buffer comprises a plurality of signal outputs. The buffer 130 is configured to output a plurality of buffer output signals via corresponding lines 140₁, 140₂, 140₃, 141₁, 141₂ and 141₃ to the transmitters 150₁-150₃ as well as 151₁-151₃ on the basis of the signal 131. The corresponding signals may represent input signals 22 of FIG. 1. It is an advantage of the use of buffers that the output signals may be provided in a synchronized way, i.e. the corresponding signals at the lines 140, 141 may be synchronized with respect to each other. In case of structures and data transmission rates that possibly cause different runtimes due to different lengths of the lines 140 and/or 141, this enables corresponding synchronization while disregarding the runtime differences.

Buffers that may be used in the context of embodiments described herein may comprise an amplification factor from the received signal to the provided signal of approximately 1. However, some embodiments advantageously use a buffer configured for a signal amplification, i.e. with an amplification factor of larger than 1, e.g. at least 2, at least 3, at least 5, or at least 10, and/or for signal processing, e.g. in the form of predistortion, equalization, post-emphasis and/or pre-emphasis.

In other words, e.g., if other means such as microcontrollers or the like would provide corresponding signals at different points in time at different outputs, in the context of the embodiments, the synchronization unit and the interconnected buffer would make it possible to still synchronously output the corresponding signals to the lines 140 and 141. As will be described below, in the case that the runtime differences due to the line lengths are to be compensated as well, further measures may be implemented, such as the use of additional buffers and/or advantageous positioning of the buffer.

With the implementation of the device 30 described, it is possible that an optical receiver 160 of an oppositely arranged device, cf. FIG. 2, always receives the optical system of at least one of the optical transmitters 150₁ to 150₃, 151₁ to 151₃, based on the light shaping of the optical transmitters 150, 151 and the operating distance set therewith.

In other words, FIG. 3 schematically shows a bidirectional embodiment in the top view. It essentially shows the components of the ring 110a and it additionally shows the receiver 160 of the second ring. All components of the rings are located on the carrier/substrate/circuit board 110a, 110b comprising a ring structure, wherein the free inner diameter 111, 111a, 111b is characteristic. The controller block 120 acts as a data source and a data sink. The data signal is directly distributed to the sub-transmitters 150₁, 150₂, 150₃, 151₁, 151₂, 151₃ via the signal lines 140₁, 140₂, 140₃, 141₁, 141₂, 141₃. When driving many sub-transmitters, it makes sense to use an additional buffer 130 connected via the signal line 131. The buffer is characterized by a particularly low jitter (<<500 ps) between the channels. With respect to their lengths, the data lines 140₁, 140₂, 140₃, 141₁, 141₂, 141₃ are tuned such that the data is received and transmitted by the sub-transmitters simultaneously. The signal transmitted by the sub-transmitters reaches a receiver 160 located on the second ring, which may be arranged opposite, wherein both rings can be rotated with respect to each other. Here, it is conceivable that the transmitter is rotated and the receiver stands still. It is also conceivable that the transmitter stands still and the receiver is rotated. However, it is also conceivable that the transmitter and the receiver are rotated together with a same or different speed or in opposite directions or that they stand still. The arrow 161 indicates the exemplary rotational movement of the receiver. In this design example, the axis of rotation 112 is located in the center of the system.

For a bidirectional data link, the ring 110a also comprises a receiver 170 placed along the ring. It is advantageous, but not necessarily required, to place the receiver 170 close to the controller 120 so as to keep the data lines as short as possible. The receiver 170 receives its signal from the sub-transmitters 190₁, 190₂, 190₃, 191₁, 191₂, 191₃, seated on the ring 110b.

The number of sub-transmitters illustrated is considered to be an example. In further embodiments, significantly more sub-transmitters may be used, e.g. <10, <20, <50, <100 sub-transmitters.

Embodiments are neither limited to the number of 2 optical transmitters according to FIG. 1, nor to 6 optical transmitters according to FIG. 2 or 3. A different number of at least 2, such as at least 3, at least 4, at least 5, at least 6, at least 8, at least 10, or more optical transmitters is easily possible.

In other words, sub-transmitters 150₁-151₃ are arranged along the ring circumference 161 and an optical receiver 160 is arranged on an opposite non-illustrated ring.

In embodiments, to keep the jitter of the signal between the sub-transmitters to a minimum, it is advantageous to tune the signal line as well as possible with respect to the line length and the impedance, i.e. the influences of the line length and the impedance are to be kept equal and tuned with respect to each other. In this case, the line length determines the runtime that the signal needs to travel the distance. The impedance determines the extent to which reflections occur, which can lead to signal distortions. The signal lines 140₁, 140₂, 140₃, 141₁, 141₂, 141₃ may be configured as a single wire or in a differential manner. A differential signal layout enables greater immunity with respect to external influences, i.e. a better electromagnetic compatibility. Electromagnetic compatibility can be further improved by shielding the signal lines 140₁, 140₂, 140₃, 141₁, 141₂, 141₃. This may be achieved by means of a dedicated shield, or by leading the signal lines on the intermediate sheets of the circuit board (i.e. the outer copper sheets possibly used as planar ESD and EMI shield). A further advantage of signal lines within the circuit board of the substrate 110a, 110b are manufacturing-related precise tolerances of inner sheets.

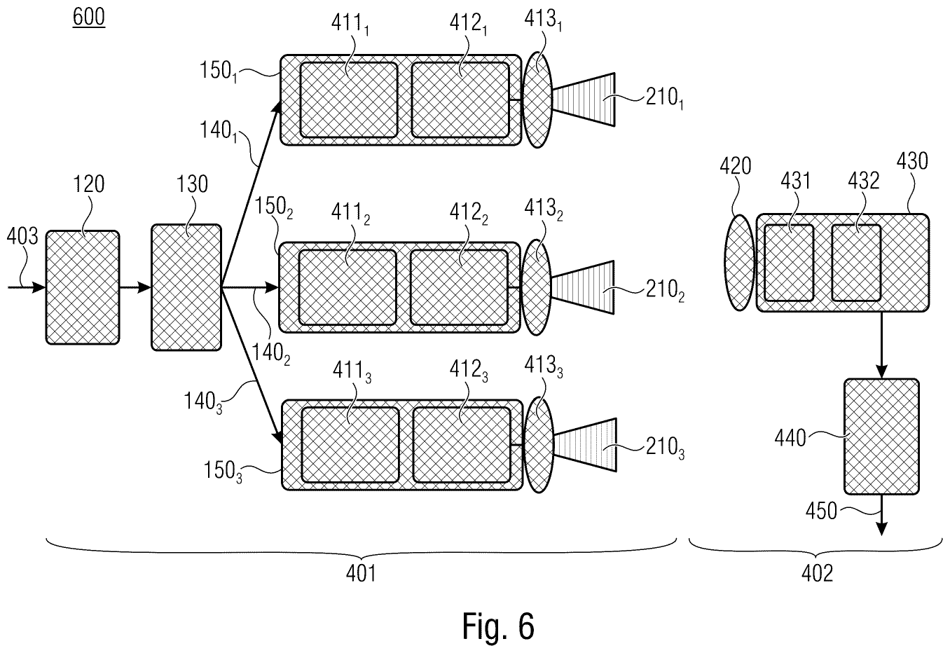

The controller block 120 exemplarily includes a microcontroller or a field-programmable gate array (FPGA), an application-specific integrated circuit (ASIC) or a comparable computing unit for data processing and generation, as well as possibly downstream signal amplifiers. The signal amplifiers on the transmission side may be adaptively driven by the signal source or the controller 120 or 180 so as to save power in the case of a low load of the data channel or to increase the life cycle of the components. The amplifier of the receiver side 170 is located close to the block 120, as is shown in FIG. 6 on the basis of the amplifier 432 and the controller block 400. In this case, the selection of the controller block 120 influences the possible data rate as well as the extent of further optional functions, such as the adaptive transmitter.

In an advantageous but non-limiting embodiment, the sub-transmitters 150₁, 150₂, 150₃, 151₁, 151₂, 151₃ are placed such that an opposite receiver 160 always detects the signal of at least one sub-transmitter 150₁, 150₂, 150₃, 151₁, 151₂, 151₃ regardless of the position. Optically, each sub-transmitter covers a sub-area of the ring.

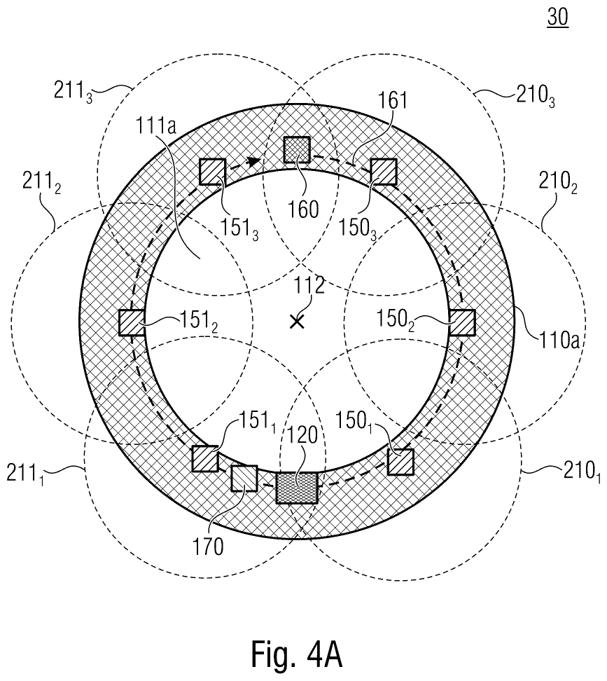

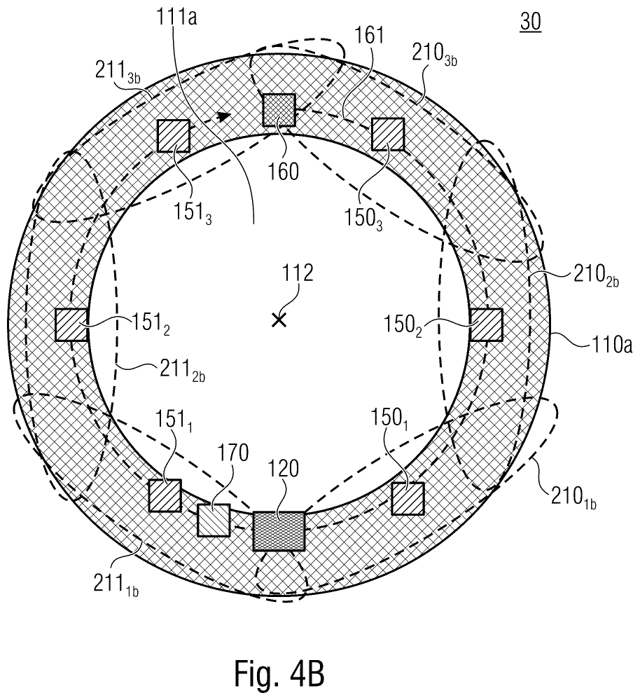

FIG. 4a shows an embodiment in which each sub-transmitter 150₁, 150₂, 150₃, 151₁, 151₂, 151₃ covers a circular area 210₁, 210₂, 210₃, 211₁, 211₂, 211₃, which can be adapted via the radiation characteristic. In this case, the individual areas 210₁, 210₂, 210₃, 211₁, 211₂, 211₃ of the sub-transmitters possibly overlap so as to ensure a safe transition of the opposite receiver 160, 430 from a sub-transmitter to another sub-transmitter. As FIG. 4b shows, the coverage area of the sub-transmitter may also have any other shape, such as an elliptical shape, cf. illumination areas 210_{1b}, 210_{2b}, 210_{3b}, 211_{1b}, 211_{2b}, 211_{3b}. The shape of the illumination areas, synonymously called coverage areas (or ranges), is created by optical emitters 412₁, 412₂, 412₃, . . . , in the transmitter itself, or by additional lenses, multi-path lenses or mirrors 413₁, 413₂, 413₃, . . . , and/or other optically effective elements such as a reflector and/or a diffuser, which may be part of at least one optical transmitter, as illustrated in FIG. 6, so as to optically shape, e.g. collimate and/or scatter light generated by the optical transmitter on the basis of the input signal. This may be based on different motivations, e.g. to better illuminate the ring area or the movement path; to collimate the beams, e.g. so that the optical runtime differences are minimal or differences that would arise due to a divergence of the beam from a beam center to a beam edge are avoided, and/or to increase eye safety so that the optical power per transmitter can be increased in order to cover a larger area per transmitter. In such an implementation, at least one of the optical transmitters may include a multi-path lens configured to divide a light output generated by the optical transmitter into a plurality of partial light beams on the basis of the input signal. Such a multi-path optical system is described, e.g. in DE 10 2020 206 180 A1.

It is particularly advantageous if the coverage area corresponds well to the circular structure of the opposite receiver 160, 420/430. The use of a lens or a mirror that enlarges the expansion of the apparent source of the single light emitter is suitable, e.g. as is the case in a multi-path lens. Thus, it is possible, in light of eye safety, to increase the power per partial transmitter 150₁, 150₂, 150₃, 151₁, 151₂, 151₃, enabling a partial transmitter with a larger coverage area. This may help to reduce the number of partial transmitters and to save costs.

FIG. 4a shows a schematic top view onto the device 30 according to FIG. 3, wherein radiation areas 210₁-210₃ as well as 211₁-211₃ of the optical transmitters 150₁-150₃ as well as 151₁-151₃, e.g. the coverage areas 38 of the device 10, are configured so as to be circular, which is an optional implementation, however not required. The areas 210 and 211 are illustrated as being at the location of the opposite receiver device, e.g. the device 25 with respect to the device 20 or the device 20 with respect to the device 25, and in particular for a scenario in which the optical receiver 160 of the opposite device is able to receive light from at least one of the optical transmitters 150, 151 at each point in time of the relative movement along the circular path 161.

In other words, FIG. 4a shows an embodiment of a transmitter ring, wherein each sub-transmitter 150₁, 150₂, 150₃, 151₁, 151₂ and 151₃ covers a circular area 210₁, 210₂, 210₃, 211₁, 211₂ and 211₃ in which the opposite receiver 160 is able to receive a signal.

FIG. 4b shows an embodiment in which, using previously described possibilities, each sub-transmitter 150₁, 150₂, 150₃, 151₁, 151₂ and 151₃ covers an exemplarily elliptical area 210_{1,b}, 210_{2,b}, 210_{3,b}, 211_{1,b}, 211_{2,b} and 211_{3,b} in which the opposite receiver is able to receive a signal. Other shapes of the coverage areas 210, 211 are readily possible. It is also possible to implement optical transmitters with different geometries of the coverage areas.

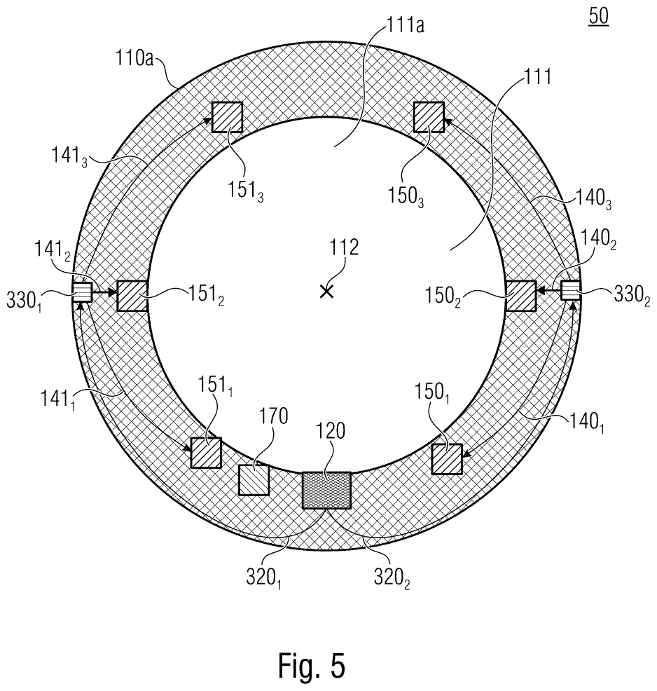

FIG. 5 shows a schematic top view onto an optical device 50 according to an embodiment, comprising several modifications compared to the device 30, which may be implemented individually, in groups, or together, however, which do not require each other.

Thus, the signal source 120 is configured to provide the signal 16 described in FIG. 1 to two or more data lines 320₁ and 320₂. Furthermore, instead of only one buffer 130 of the device 30, a plurality or even multitude of buffers is provided, e.g. buffers 330₁ and 330₂, which may be formed in accordance with the buffer 130.

Each of the buffers 330₁ and 330₂ is coupled to a subset of the total number of optical transmitters 150₁-150₃ as well as 151₁-151₃, which makes it possible to keep the lengths of the data lines between the buffer and the optical transmitter comparably short. For example, as an alternative to a division of six optical transmitters into two groups having three optical transmitters each, a different division is also possible, e.g. a number of three buffers coupled to two optical transmitters each, or different therefrom, considering a possibly different number of optical transmitters overall. It is also possible to provide further additional buffers and to employ them in a cascaded arrangement, for example. Thus, e.g., a non-illustrated further buffer may be coupled to the signal line 131 of FIG. 3, or to one of the signal lines 320₁ or 320₂ of FIG. 5, and may then itself supply two or more buffers with input signals.

The subsets of the optical transmitters, e.g. the optical transmitters 150 on the one hand and 151 on the other hand, illustrated in FIG. 5, may together fully cover a transmitter area, e.g. area of the substrate of the ring 110a, and the respective subset 150, 151 may essentially cover sub-areas of the transmitter area having the same size. In the illustration of FIG. 5, e.g., this could be halves of the ring 110a.

In other words, as FIG. 5 exemplarily shows, the signal may also be distributed, by the controller block 120, across several data lines 320₁, 320₂ to several buffers 330₁, 330₂. By using several buffers 330₁, 330₂, . . . , several sub-transmitters 150₁, 150₂, 150₃, 151₁, 151₂, 151₃ may be addressed, or a larger distance between the sub-transmitters may be realized. In case of a high number of sub-transmitters (>10, >20, >50, >100), it is conceivable to cascade the buffers and connect them consecutively. In order to decrease the absolute line lengths and the jitter, it is advantageous to always place the buffer 130, 330₁, 330₂, . . . in the center of the portion that the buffer is to cover. In FIG. 3, this means that the buffer 130 is placed in the center and covers one half of the ring each in both directions. In FIG. 5, a buffer 330₁, 330₂, . . . , 330ₙ covers one half of the ring each or an n-fold part of the ring of the same size, and is advantageously placed in the center of the corresponding ring half and the n-fold sub-piece. In an implementation in which the buffers are cascaded several times, the buffers are rearranged in the center of their sub-transmitters that are to be contacted. Thus, there may be an approximately identical total line length for each sub-transmitter and an equal data signal by using the buffers.

Installation spaces for line layouts are usually limited. Nevertheless, embodiments provide implementing additional line lengths, e.g. to reduce the runtime deviation between a buffer 330₁ and the optical transmitter 151₁ on the one hand and the buffer 330₁ and the optical transmitter 151₃ on the other hand.

In other words, FIG. 5 shows an embodiment of the transmitter ring with one buffer 330₁ and 330₂ each for each half of the ring.

FIG. 6 shows a schematic block circuit diagram of at least one part of a system arrangement of embodiments described herein. For example, the system 600 includes a device 401 that transmits, by using the optical transmitters 150₁, 150₂ and 150₃, several mutually synchronized optical signals 210₁, 210₂ and 210₃, wherein each of the optical signals 210₁-210₃ may be in accordance with the optical-wireless signals 12.

In other words, FIG. 5 shows an embodiment of a transmitter ring with one buffer each for each half of the ring.

FIG. 6 shows a schematic block circuit diagram of a system 600 according to an embodiment, wherein a device 401 is configured as a transmitter ring 20, 25, 30 and/or 50 described herein, having one buffer 330₁ and 330₂ each for each half of the ring, for example. FIG. 6 shows the combined blocks of the diagram of a sub-transmitter section in the context of the embodiments. It shows an exemplary transmitter part 401 with a receiver 402, e.g. a device with the optical receiver 160, which may be readily formed identically or as a mirroring device with respect to the device 401, e.g. to implement bidirectional transmission.

The controller block 120 may have an input interface for receiving an input signal 403, via which the controller block 120 may receive data, e.g., wherein this is optional when using a storage of the controller 120. The controller block 120 transmits the signal to an optional buffer 130 that distributes the electric signal via the signal lines 140₁, 140₂, 140₃ to the sub-transmitters 150₁, 150₂, 150₃. The sub-transmitters 150₁, 150₂, 150₃ consist of an optional buffer/driver circuit 411₁, 411₂, 411₃ and an optional emitter 412₁, 412₂, 412₃, e.g. a light diode (LED, light emitting diode), or a laser (e.g. a laser diode, such as a vertical cavity surface emitting laser, or VCSEL) and an optional lens 413₁, 413₂, 413₃ each, and generate the coverage areas 210₁, 210₂, 210₃, 210_{1b}, 210_{2b}, 210_{3b}.

The receiver 402 includes an optional lens 420 configured to focus the incident light onto the receiver 430. The receiver includes a photodetector 431 and an optional amplifier 432. For example, the amplifier 432 may be a transimpedance amplifier or a voltage amplifier. The signal is then transmitted to a controller block 440, such as the controller block 180, configured to decode the signal or to forward the same via an optional interface 450. In other words, FIG. 6 shows a schematic illustration of an embodiment of an exemplary transmitter 401 and a receiver 402.

It is advantageous for signal quality, error rate, reliability, aging behavior and costs if the reception level varies as little as possible via a full rotation. Usually, however, the coverage areas 210₁, 210₂, 210₃, 211₁, 211₂, 211₃, 210_{1b}, 210_{2b}, 210_{3b}, 211_{1b}, 211_{2b}, 211_{3b} are not illuminated homogenously. As a result, e.g., the signal level is very high if the receiver 160 is opposite a sub-transmitter, and is very low if the receiver is located centrally between two sub-transmitters.

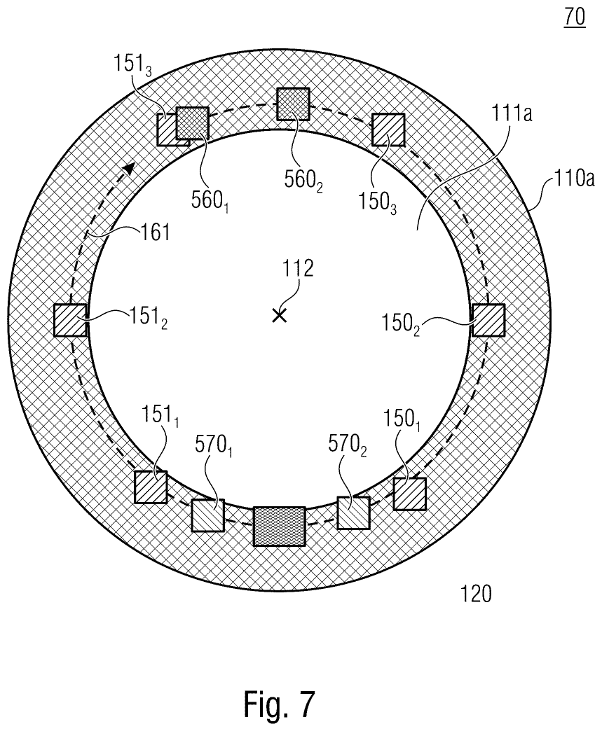

FIG. 7 shows in an exemplary top view onto a device 70 according to an embodiment that this problem may also be addressed by using two receivers 560₁, 560₂ or 570₁, 570₂, e.g. in accordance with the optical receivers 34, 20, 25 and/or 402. In other words, FIG. 7 shows a schematic illustration of an embodiment of a rotary transmitter with two receivers 560₁, 560₂.

It is also conceivable to further increase the number of receivers. It is particularly advantageous for the reception level if the receivers 560₁, 560₂, e.g. in accordance with the optical receiver 160 and/or 170 and/or 430, comprise, precisely or essentially, i.e. within a tolerance range of at most 20%, at most 10% or less, e.g. at most 5%, half of the distance of two sub-transmitters or an odd-numbered integer multiple of half of the distance of two transmitters. This can ensure that one of the two receivers 560₁, 560₂ always detects a sufficiently strong signal if the other one currently has an unfavorable position with a low reception level. In this way, it is even possible that the sub-transmitters do not illuminate the full ring, but that they may have discontinuations.

When using several receivers 560₁, 560₂, the number of the sub-transmitters may possibly be reduced to reduce costs and power consumption. In such an implementation, when using several optical receivers, a system according to an embodiment may comprise a first optical receiver and a neighboring second optical receiver with a distance that is essentially half of a distance between two neighboring optical transmitters of the first device. The receiving device may comprise an amplifier circuit, e.g., the amplifier 432, coupled to the first optical receiver and the second optical receiver so as to amplify a first receiver signal of the first optical receiver and a second receiver signal of the second optical receiver. Alternatively or additionally, a respective amplifier circuit may be provided for individual optical receivers of the device, wherein a first amplifier circuit is configured to amplify a first receiver signal of the first optical receiver so as to provide a first amplified signal; and a second amplifier circuit is configured to amplify a second receiver signal of the second optical receiver so as to provide a second amplified signal. A processing unit (or processing means), such as the controller 440, 120, 180 or the signal source 14, may be configured in such an implementation for combining the first amplified signal and the second amplified signal. A combination may also be carried out in the controller and following the amplifier circuit (e.g. by adding the signals). Alternatively or additionally, two or more optical receivers may be configured with an individual first amplifier circuit or a second amplifier circuit, respectively, configured to amplify a first receiver signal of the first optical receiver so as to provide a first amplified signal; and with a second amplifier circuit configured to amplify a second receiver signal of the second optical receiver so as to provide a second amplified signal. The receiver device may comprise a processing unit (or processing means), such as the controller 440, 120, 180 or the signal source 14, configured to carry out data processing of amplified signals and select, for data processing, one of the first amplified signal and the second amplified signal. For example, a selection of the further processed signal may be carried out on the basis of a signal quality or exceeding a signal minimum quality for a subsequent optical signal, or the like. Switching may be done at an appropriate or a predetermined point in time, e.g. between data packets. To this end, it is conceivable, e.g., to use a time sensitive networking (TSN) standard.

In other words, the receivers 560₁, 560₂, . . . may be two or more individual receivers with their own photodetector, amplifier circuit, and controller. However, it is also conceivable that two or more photodetectors are connected to the same amplifier and that the combined signal is then processed by the controller. It is also conceivable that each of the photodetectors comprises a separate transimpedance amplifier and that the output signals are then added. This variation is advantageous for the bandwidth of the transimpedance amplifier stage. Although the noise in the signal is increased in this way, the advantage over the strongly varying reception level is significantly larger.

A further alternative uses optics (e.g. an optical fiber or beam optics) so as to generate the two input apertures for the receiver 560₁, 560₂. The signal strikes the optics and is then guided to a single photodetector for the receivers 560₁, 560₂, e.g., located in the center of both apertures. The signal is subsequently amplified and processed by a controller. The advantage of this concept is that only one photodetector, amplifier, and controller is required.

When using more than two receivers, the concepts may also be combined.

Modifications of embodiments described herein are also possible, as an alternative or addition to other modifications with respect to the transmitter-receiver arrangement. In the embodiments of FIGS. 4, 4a, 4b, 5 and/or 7, the sub-transmitters 150₁, 150₂, 150₃, 151₁, 151₂, 151₃, 190₁, 190₂, 190₃, 191₁, 191₂, 191₃ and the receiver 160, 170 may be arranged in a similar or even equal distance to the axis of rotation 112, i.e. the radial distance is essentially equal. For example, this is advantageous for a small installation space or a multi-channel rotary transmitter. Obviously, the system may also be configured differently, that is, there may be any distance of the sub-transmitters and the receivers with respect to the axis of rotation 112.

A possible variation of embodiments described herein is the provision of at least one further channel for energy transmission or data transmission for obtaining a multi-channel system. In order to provide even higher data rates or separated communication channels, it is conceivable to configure the rotary transmitter as a multi-channel rotary transmitter.

In this case, several rings may be arranged radially next to each other, i.e. the further away a channel is from the axis of rotation 112, the larger its ring diameter. In such a system, the number of sub-transmitters or receivers may be increased towards the outside. For such an arrangement it is advantageous if the sub-transmitters 150₁, 150₂, 150₃, 151₁, 151₂, 151₃, 190₁, 190₂, 190₃, 191₁, 191₂, 191₃ and the receivers 160, 170 have the same or a similar radial distance. It is also conceivable that neighbouring channels differ with respect to their wavelength so as to avoid optical crosstalk. To reduce crosstalk, a shielding element such as a ring/wall/filter may also be inserted between the channels.

According to an embodiment, in a system described herein, at least the receiver device and/or the transmitter device of the second device comprises a further plurality of synchronized optical transmitters so as to provide a second optical-wireless communication channel.

The number of channels may also be increased, e.g. by stacking rotary transmitters, e.g. along the axis of rotation 112.

In some embodiments, e.g. FIGS. 2, 3, 4a, 4b and/or 5, the data transmission may take place in parallel to the axis of rotation. For example, it is also conceivable to communicate perpendicularly to the axis of rotation, e.g. in a radial direction towards the outside or the inside. For example, the sub-transmitters then have a smaller ring diameter than the associated receiver or vice versa. In this case, in order to realize a bidirectional channel, two of these unidirectional rings may be stacked. Alternatively, they may also be placed radially next to each other, i.e. the forward channel would have a different radial distance to the rotation axis.

Alternatively or additionally to the data transmission, a system described herein may be configured to transmit electric energy on the basis of at least one optical-wireless energy signal and from a first to a second device or from the second to the first device, i.e. energy transmission may be realized in an optical-wireless way. The optical energy transmission, among other things, has the advantage that it is not susceptible to interference from the outside and towards the outside. In addition, the optical-wireless energy enables galvanic separation, i.e. electric insulation. In contrast to optical-wireless data transmission, the optical-wireless energy transmission is typically configured so as to be unidirectional. The direction which energy is transmitted is arbitrary.

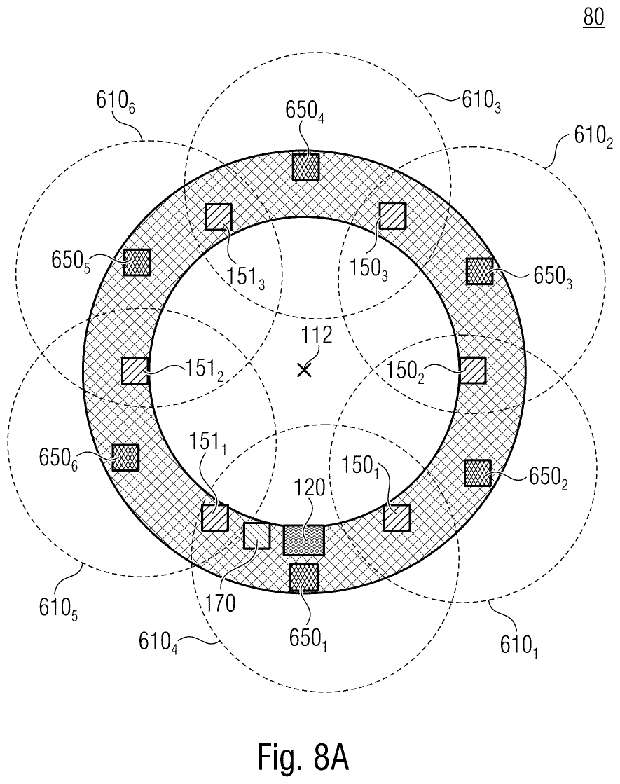

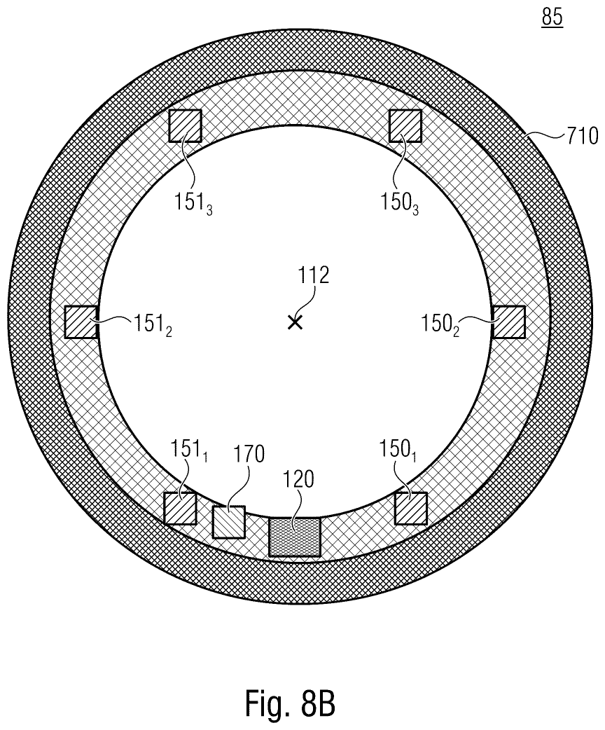

FIG. 8 shows a schematic top view of such a transmitter ring of the rotary transmitter with optical-wireless energy transmission. In addition to the optional optical transmitters 150 and 151, the same comprises additional optical emitters 650₁, 650₂, 650₃, 650₄, 650₅, 650₆. These can be LEDs, laser diodes (e.g. VCSEL) or similar components. The additional emitters may be arranged along the ring and advantageously so that their covering areas 610₁, 610₂, 610₃, 610₄, 610₅, 610₆ cover the entire ring circumference. In other words, FIG. 8a shows a schematic illustration of an embodiment of a transmission ring of a rotary transmitter with an additional energy transmission via the optical emitters 650₁, 650₂, 650₃, 650₄, 650₅, 650₆.

FIG. 8b shows a schematic top view onto a reception ring of the rotary transmitter with optical-wireless energy transmission. For example, one or more additional detectors 710 may be arranged around the area used for data transmission in order to detect the optical power of the optical emitters 650₁, 650₂, 650₃, 650₄, 650₅, 650₆ and to convert the same into electric power. The detector 710 may, e.g., be one or more photovoltaic cells. The shape of the detector is only exemplarily and may be any shape. The detectors may also be distributed between the transmission and reception elements. In other words, FIG. 8b shows a schematic illustration of an embodiment of a reception ring of a rotary transmitter with the additional detector 710.

Although some embodiments are described in such a way that the optical transmitters and receivers are arranged in a circular path, an ellipse, a straight line or another shape is also readily possible. The statement that the buffers are advantageously placed in the center of each of the partial transmitters that they cover remains valid.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable. Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer. The program code may also be stored on a machine-readable carrier, for example.

Other embodiments include the computer program for performing any of the methods described herein, said computer program being stored on a machine-readable carrier.

In other words, an embodiment of the inventive method thus is a computer program which has a program code for performing any of the methods described herein, when the computer program runs on a computer. The data carrier, the digital storage medium, or the recorded medium are typically tangible, or non-volatile. A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing unit (or processing means), e.g. a computer or a programmable logic device, configured or adapted to perform any of the methods described herein.

A further embodiment includes a computer on which the computer program for performing any of the methods described herein is installed.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### BIBLIOGRAPHY

[1] A. Doleschel and M. Lege, “Contactless solutions for radar rotary joint systems,” in 2015 16th International Radar Symposium (IRS), Dresden, Germany, 2015, pp. 451-456.
[2] F. Yuanshuang, H. Hongsheng, S. Yue, H. Han, and W. Sihan, “A Simultaneous Wireless Power and Coil Inductance Insensitive Data Transfer System for Rotary Structures,” IEEE Trans. on Power Electronics, 2024.
[3] C. Panhans and R. Stolle, “High Bandwidth Contactless Rotary Transmitter Design Optimized for Baseband Transmission,” in 2019 11th International Conference on Information Technology and Electrical Engineering (ICITEE), Pattaya, Thailand, 2019, pp. 1-6.
[4] X. He, W. Shu, B. Yu, and X. Ma, Wireless Power Transfer System for Rotary Parts Telemetry of Gas Turbine Engine. [Online]. Available: https://www.mdpi.com/2079-9292/7/5/58 (accessed: Feb. 3 2025).
[5] Anton Patyuchenko, “60 GHz Wireless Data Interconnect for Slip Ring Applications,” Analog Devices, 2019.
[6] M. Faulwaßer, R. Kirrbach, T. Schneider, and A. Noack, “10 Gbit/s bidirectional transceiver with monolithic optic for rotary connector replacements,” in 2018 Global LIFI Congress, 2018, pp. 95-102.
[7] M. Faulwaßer, R. Kirrbach, S. Tobias, A. Noack, and F. Deicke, “Solderable Multi-Gigabit Optical Wireless Transceiver for Rotary Communication Setups,” in Optical Wireless Communication Conference 2021.
[8]

R. Kirrbach, M. Faulwaßer, T. Schneider, P. Meißner, A. Noack, and F. Deicke, “Monolitic Hybrid Transmitter-Receiver Lens for Rotary On-Axis Communications,” Applied Sciences, vol. 10, no. 4, p. 1540, 2020, doi:
10.3390/app10041540.
[9] T. Helzel and G. Martens, “Optical slip ring for off-axis high-bit-rate data transmission,” Applied optics, vol. 25, no.

1. Device for transmitting optical-wireless signals, comprising:
a signal source for providing at least one signal;
a plurality of spatially distributed optical transmitters for transmitting a corresponding plurality of optical-wireless signals;
a synchronization unit configured to convert, for the plurality of optical transmitters, the at least one signal into a corresponding plurality of mutually synchronized input signals;
wherein the device is configured to, based on the at least one signal, with the plurality of optical transmitters, based on the plurality of mutually synchronized input signals, transmit the plurality of optical-wireless signals in a spatially distributed way as mutually synchronized optical-wireless signals.

2. Device according to claim 1, wherein the plurality of optical transmitters is a first plurality of optical transmitters for a first optical-wireless communication channel and the device comprises at least a second plurality of synchronized optical transmitters to provide a second optical-wireless communication channel, wherein the first plurality and the second plurality are arranged on different concentric paths.

3. Device according to claim 1, wherein the synchronization unit is configured to actively compensate different runtimes of the at least one signal from the signal source to the plurality of optical transmitters; and/or is configured to electrically passively compensate different distances between the signal source and the plurality of optical transmitters.

4. Device according to claim 1, wherein the synchronization unit comprises a buffer comprising a signal input coupled to the signal source so as to receive the signal;
wherein the buffer comprises a plurality of signal outputs and is configured to output, on the basis of the signal, a plurality of buffer output signals as synchronous buffer output signals,
wherein the at least one subset of the plurality of optical transmitters is coupled to the signal outputs and their input signals are based on the buffer output signals or are the buffer output signals.

5. Device according to claim 4, wherein positions of the optical transmitters coupled to the signal outputs define a transmitter area of the device, and the buffer is essentially arranged in the center of the transmitter area; or neighboring optical transmitters arranged along different signal paths starting from the signal source comprise an essentially equal distance and/or runtime delay of the input signals;
wherein the device comprises a plurality of buffers, wherein each of at least a subset of the plurality of buffers is coupled to a subset of the plurality of optical transmitters.

6. Device according to claim 5, wherein the plurality of buffers forms a cascading arrangement of buffers.

7. Device according to claim 4, wherein the buffer is configured for signal amplification and/or signal processing.

8. Device according to claim 1, wherein the plurality of optical transmitters is arranged along a circular path;
wherein the plurality of optical transmitters is arranged on or in a carrier substrate comprising an annular geometry and the plurality of optical transmitters is arranged annularly.

9. Device according to claim 1, wherein the signal source is configured for data processing, and comprises a signal amplifier, and the amplification of the signal amplifier is controllable.

10. Device according to claim 1, wherein one, several, or all of the optical transmitters comprise a buffer circuit and/or a driver circuit and an optical emitter.

11. Device according to claim 1, wherein at least one of the optical transmitters comprises a multi-path lens configured to split light power of light generated by the optical transmitter on the basis of the input signal into several light sub-bundles.

12. System for transmitting optical-wireless signals, comprising:
a device according to claim 1 as a first device; and
a second device for receiving at least a subset of the synchronized optical-wireless signals.

13. System according to claim 12, wherein at least the second device comprises a plurality of spatially distributed optical receivers; and wherein the second device comprises an amplifier unit coupled to at least one of the plurality of optical receivers and arranged close to the optical receiver.

14. System according to claim 12, wherein at least the second device comprises a plurality of spatially distributed optical receivers; and
comprising an amplifier circuit coupled to the first optical receiver and the second optical receiver to amplify a first receiver signal of the first optical receiver and a second receiver signal of the second optical receiver; or
comprising a first amplifier circuit configured to amplify a first receiver signal of the first optical receiver to provide a first amplified signal; and a second amplifier circuit configured to amplify a second receiver signal of the second optical receiver to provide a second amplified signal;
wherein the second device comprises a processing unit for combining the first amplified signal and the second amplified signal; or
comprising a first amplifier circuit configured to amplify a first receiver signal of the first optical receiver to provide a first amplified signal; and a second amplifier circuit configured to amplify a second receiver signal of the second optical receiver to provide a second amplified signal;
wherein the second device comprises a processing unit configured to perform data processing of amplified signals and to select one of the first amplified signal and the second amplified signal for the data processing.

15. System according to claim 12, wherein at least the second device comprises a plurality of spatially distributed optical receivers; wherein a movement path of a relative movement between the first device and the second device is arranged such that, in each relative position of the relative movement, at least one optical transmitter of the first device is arranged in a reception area of an optical receiver of the second device.

16. System according to claim 12, configured to illuminate with each of the plurality of synchronized optical-wireless signals a sub-area of a total area, wherein the sub-areas overlap at the second device.

17. System according to claim 12, wherein the plurality of synchronized optical-wireless signals is a first plurality of synchronized optical-wireless signals of a first optical-wireless communication channel, and the first and/or second device comprises at least a second plurality of synchronized optical transmitters to provide a second optical-wireless communication channel;
wherein the first plurality and the second plurality are arranged on different concentric paths.

18. System according to claim 12, configured for bidirectional transmission of optical-wireless signals.

19. System according to claim 12, configured for transmitting electrical energy based on at least one optical-wireless energy signal and from the first to the second device or from the second to the first device.

20. System according to claim 19, comprising optical emitters for transmitting the at least one optical-wireless energy signal, wherein the optical emitters are arranged along a movement path of a relative movement between the first device and the second device and cover areas of the optical emitters collectively cover the entire trajectory.
